(19) United States
(12) Patent Application Publication
(10) Pub. No.: US 2025/0310101 A1
(43) Pub. Date: Oct. 2, 2025

(54) TRANSMISSION DEVICE, RECEPTION DEVICE, INFORMATION PROCESSING METHOD, PROGRAM, AND COMMUNICATION SYSTEM

(71) Applicant: SONY SEMICONDUCTOR SOLUTIONS CORPORATION, KANAGAWA (JP)

(72) Inventors: AKIHIKO NAGAO, KANAGAWA (JP); KUMIKO MAHARA, KANAGAWA (JP)

(21) Appl. No.: 18/864,598

(22) PCT Filed: May 1, 2023
(86) PCT No.: PCT/JP2023/017006

§ 371 Date: Nov. 11, 2024

(30) Foreign Application Priority Data
May 18, 2022 (JP) 2022-081334

(51) Int. Cl. H04L 9/08

(52) U.S. Cl. CPC H04L 9/0891

(57) ABSTRACT

The present technology relates to a transmission device, a reception device, an information processing method, a program, and a communication system capable of easily updating a key used for security processing performed on data output by a sensor.

A transmission device according to an embodiment of the present technology controls security processing performed on output data of each of frames output by a sensor and transmission of information indicating an update timing of a key used for the security processing to a reception device that is a transmission destination of the output data and transmitting frame data in a predetermined format used for transmission of the output data subjected to the security processing. The present technology can be applied to devices that perform communication based on an SLVS-EC standard.

### TECHNICAL FIELD

The present technology particularly relates to a transmission device, a reception device, an information processing method, a program, and a communication system capable of easily updating a key used for security processing on data output from a sensor.

### BACKGROUND ART

As standards of a high-speed communication IF, there are mobile industry processor interface (MIPI), scalable low voltage signaling-embedded clock (SLVS-EC), and the like. The standards such as MIPI and SLVS-EC are used, for example, for data transmission between an image sensor such as a CIS and a processor such as a DSP operating as a host.

### CITATION LIST

### Patent Document

Patent Document 1: Japanese Unexamined Patent Application Publication No. 2018-525866

Patent Document 2: Japanese Patent Application Laid-Open No. 2010-191728

### SUMMARY OF THE INVENTION

### Problems to be Solved by the Invention

In order to protect data output from an image sensor, a mechanism of data encryption or tamper detection using a MAC value or the like is used. A common key set in each of an image sensor and a processor is used for data encryption and tamper detection.

A key such as a common key used for security processing also has a usable period according to a scheme such as an algorithm to be employed. It is therefore necessary to update the key before the usable period expires.

It is conceivable to update a key using key distribution from a processor serving as a host as a trigger, but it is difficult for one processor to manage update timings of keys of many image sensors.

The present technology has been made in view of such circumstances, and an object thereof is to easily update a key used for security processing on data output from a sensor.

### Solutions to Problems

A transmission device according to an aspect of the present technology includes a control unit that controls security processing performed on output data of each of frames output by a sensor and transmission of information indicating an update timing of a key used for the security processing to a reception device that is a transmission destination of the output data and a first communication unit that transmits, using a first communication IF, frame data in a predetermined format used for transmission of the output data subjected to the security processing.

A reception device according to another aspect of the present technology includes a first communication unit that receives frame data in a predetermined format including output data of each of frames that has been output by a sensor and on which security processing has been performed, the frame data being transmitted, using a first communication IF, from a transmission device that performs the security processing on the output data and a control unit that controls update of a key used for the security processing in response to transmission of information indicating an update timing of the key from the transmission device.

In the aspect of the present technology, security processing performed on output data of each of frames output by a sensor and transmission of information indicating an update timing of a key used for the security processing to a reception device that is a transmission destination of the output data are controlled, and frame data in a predetermined format used for transmission of the output data subjected to the security processing is transmitted.

In the other aspect of the present technology, frame data in a predetermined format including output data of each of frames that has been output by a sensor and on which security processing has been performed, the frame data being transmitted from a transmission device that performs the security processing on the output data, is received, and update of a key used for the security processing is controlled in response to transmission of information indicating an update timing of the key from the transmission device.

### BRIEF DESCRIPTION OF DRAWINGS

FIG. 1 is a diagram illustrating a configuration example of a communication system according to an embodiment of the present technology.

FIG. 2 is a diagram illustrating a procedure of key update in the communication system of FIG. 1.

FIG. 3 is a diagram illustrating an example of data transmission by SLVS-EC.

FIG. 4 is a diagram illustrating an example of a format used for data transmission by SLVS-EC.

FIG. 5 is a block diagram illustrating a configuration example of an image sensor and a host processor.

FIG. 6 is a diagram illustrating an arrangement example of a key update warning.

FIG. 7 is a sequence diagram for explaining operations in a case where key update is performed.

FIG. 8 is a sequence diagram for explaining operations in a case where the key update is not performed.

FIG. 9 is a sequence diagram for explaining operations in a case where the key update is not performed.

FIG. 10 is a diagram illustrating a first example of update of an IV value.

FIG. 11 is a diagram illustrating a second example of the update of the IV value.

FIG. 12 is a diagram illustrating a third example of the update of the IV value.

FIG. 13 is a diagram illustrating another configuration example of the communication system.

### MODE FOR CARRYING OUT THE INVENTION

Modes for carrying out the present technology will be described hereinafter. The description is given in the following order.
1. Key Update in Communication System
2. Image Output IF
3. Configuration of Image Sensor and Host Processor
4. Operation Example Regarding Key Update
5. Key Update Timing
6. Modifications

### KEY UPDATE IN COMMUNICATION SYSTEM

### Configuration Example of Communication System

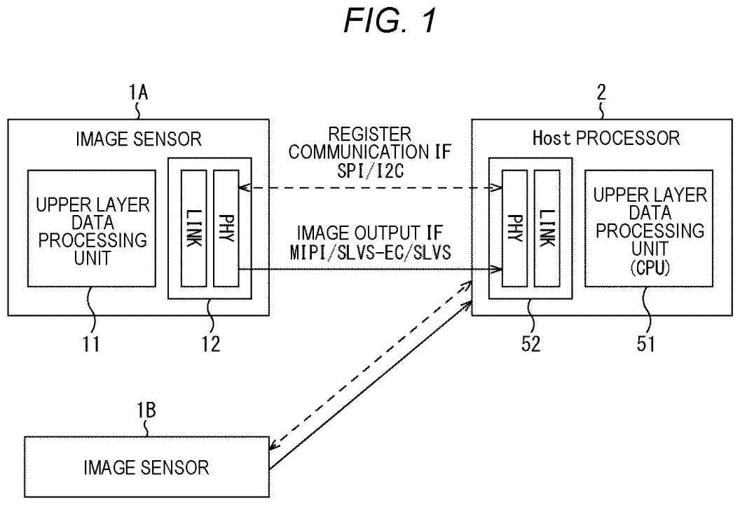

FIG. 1 is a diagram illustrating a configuration example of a communication system according to an embodiment of the present technology.

The communication system in FIG. 1 is configured by connecting image sensors 1A and 1B, which are two image sensors, and a host processor 2, which is one processor. A larger number of image sensors may be connected to the host processor 2.

The image sensors 1A and 1B and the host processor 2 may be provided in a housing of the apparatus such as a camera or a smartphone, or may be mounted in housings of different apparatuses.

The image sensor 1A and the host processor 2, and the image sensor 1B and the host processor 2, are connected by an image output IF as indicated by solid-line arrows in FIG. 1. The image output IF is a high-speed communication IF of one of certain standards including mobile industry processor interface (MIPI), scalable low voltage signaling-embedded clock (SLVS-EC), and scalable low voltage signaling (SLVS).

Furthermore, the image sensor 1A and the host processor 2, and the image sensor 1B and the host processor 2, are connected by a register communication IF as indicated by broken-line arrows in FIG. 1. The register communication IF is a communication IF using a register such as a serial peripheral interface (SPI) or an inter integrated circuit (I2C).

The image sensors 1A and 1B are sensors such as CMOS image sensors (CISs). The image sensor 1A is provided with, as illustrated in FIG. 1, an upper layer data processing unit 11 and a communication unit 12 as well as a sensor unit in which a plurality of pixels is arranged. The image sensor 1B has a similar configuration.

In a case where it is not necessary to distinguish the image sensor 1A and the image sensor 1B from each other in the following description, the image sensor 1A and the image sensor 1B will be collectively referred to as image sensors 1 as appropriate.

The upper layer data processing unit 11 of the image sensor 1 processes image data of each of frames output by the sensor unit. In the upper layer data processing unit 11, for example, security processing such as encryption and calculation of a MAC value is performed on image data.

The communication unit 12 transmits image data processed by the upper layer data processing unit 11 to the host processor 2 using the image output IF. The image sensors 1A and 1B, each of which includes the communication unit 12, function as transmission devices that transmit data to the host processor 2.

Furthermore, the communication unit 12 performs register communication, which is communication using the register communication IF, with the host processor 2. An operation mode related to imaging such as an exposure time, a gain, a resolution, and a frame rate is set through the register communication performed with the host processor 2. Furthermore, a key used for the security processing is set through the register communication.

The host processor 2 that functions as a host (master) for the register communication is provided with an upper layer data processing unit 51 and a communication unit 52.

The upper layer data processing unit 51 of the host processor 2 processes image data transmitted from the image sensor 1 and received by the communication unit 52. In the upper layer data processing unit 51, security processing such as decryption of encrypted image data and tamper detection using a MAC value is performed. The upper layer data processing unit 51 is achieved by, for example, a CPU. The upper layer data processing unit 51 will be described hereinafter as a CPU 51 as appropriate.

The communication unit 52 receives image data transmitted using the image output IF. The host processor 2 including the communication unit 52 functions as a reception device that receives data transmitted from the image sensor 1.

Furthermore, the communication unit 52 performs register communication with the image sensor 1. The communication unit 52 transmits a write command to the image sensor 1 and writes data in a register provided in the image sensor 1 to transmit the data to the image sensor 1. Furthermore, the communication unit 52 transmits a read command to the image sensor 1 and reads data stored in the register to receive the data transmitted from the image sensor 1.

Each image sensor 1 and the host processor 2 are thus connected to each other by the two communication IFs, namely the image output IF and the register communication IF. The image output IF is used to transmit and receive large data such as image data, and the register communication IF is used to transmit and receive small data such as information regarding setting of an operation mode.

### Key Update Deadline for Each Security Mode

In the image sensor 1 and the host processor 2, security processing such as encryption and decryption of image data and tamper detection using a MAC value is performed on the basis of, for example, a common key encryption scheme. An update deadline of a key that is a common key is different for each of modes of an advanced encryption standard (AES).

### AES CTR Mode

An AES CTR mode is a security mode in which encryption is performed using a key and a counter value (128 bits). The counter value is incremented every time encryption is performed. Encryption of different pieces of data using the same key and counter value is prohibited. Note that the 128-bit counter value used for encryption need not be information regarding a counter itself, and may be, for example, 64-bit data classification information to be subjected to the security processing and 64-bit counter information.

In the AES CTR mode, the key needs to be updated before the counter value reaches a maximum value.

### AES GCM/GMAC Mode

An AES GCM mode is a security mode in which encryption and tamper detection are performed using a key and an IV value (96 bits). The AES GMAC mode is a security mode in which tamper detection is performed using a key and an IV value (96 bits). The IV value is incremented every time encryption or the like is performed. Encryption of different pieces of data and tamper detection using the same key and IV value are prohibited. Note that the 96-bit IV value used for encryption and tamper detection need not be the information regarding the counter itself, and may be, for example, 32-bit data classification information to be subjected to the security processing and the 64-bit counter information.

In the AES GCM/GMAC mode, the key needs to be updated before the IV value reaches a maximum value.

### AES CMAC Mode

An AES CMAC mode is a security mode in which tamper detection is performed using a key. According to NIST SP800-38B Annex B, in the AES CMAC mode, the key needs to be updated within 2\hat{ }48 messages.

### Methods for Updating Key

Methods for updating a key generally include key distribution and key derivation.

The key distribution is a method in which a host transmits keys to sensors at arbitrary timings to update the keys. In each sensor, a setting for using the key received from the host for subsequent security processing is made. Different keys may be set for different sensors, or the same key may be set for different sensors.

The key derivation is a method in which a host and sensors derive keys at preset update timings to update the keys. An arbitrary timing, such as a timing at which a predetermined number of pieces of image data have been transmitted, is set in advance as a key update timing between the host and each sensor. In general, different keys are derived for different sensors.

In the communication system of FIG. 1, the update of keys (key update) is performed through the key distribution.

### Procedure of Key Update in Communication System

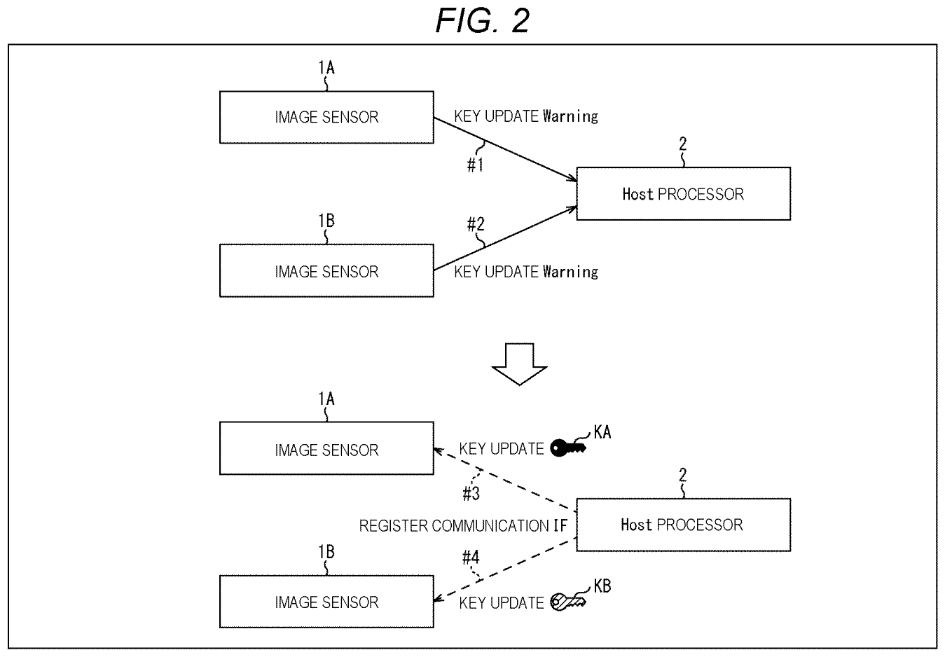

FIG. 2 is a diagram illustrating a procedure of the key update in the communication system of FIG. 1.

In the communication system of FIG. 1, each image sensor 1 manages the key update timing. As indicated by arrows #1 and #2 in an upper part of FIG. 2, the image sensor 1 transmits a key update warning to the host processor 2 before a key update deadline expires. The key update warning is information used for notification of the key update timing.

The key update warning is transmitted using the image output IF or the register communication IF as described later.

The host processor 2 that has received the key update warning updates the key through the key distribution as illustrated in a lower part of FIG. 2. In an example in the lower part of FIG. 2, a key KA that is a new key is distributed to the image sensor 1A, and a key KB that is a new key is distributed to the image sensor 1B as indicated by arrows #3 and #4. The key KA and the key KB are, for example, different keys.

The key distribution is performed using the register communication IF. For example, the key distribution is achieved by communicating information for setting a new key using the register communication IF.

After the key is updated, the image sensor 1 performs security processing using the new key.

In the communication system of FIG. 1, each image sensor 1 thus manages the key update timing. The host processor 2 need not manage the key update timing of each image sensor 1.

In a case where the host processor 2 manages the key update timings of all the image sensors 1, the management is troublesome if the number of image sensors 1 is large. Since each image sensor 1 manage the key update timing, a load on the host processor 2 can be reduced, and the key used for security processing performed on data output from the image sensor 1 can be easily updated.

Note that a load of processing image data in the host processor 2 might be large and the key might not be updated by the update deadline. In this case, an error notification is transmitted from the image sensor 1 to the host processor 2. An error notification is information indicating that image data output from the image sensor 1 is in an error state. In a case where an error notification is issued, for example, image data returns from an error state to a normal state at a time of update of the key.

If the key cannot be updated by the update deadline, the image sensor 1 may transmit blank image data to the host processor 2 with emphasis on confidentiality. Blank image data is, for example, data of a black image in which invalid values are set as pixel values of all pixels.

Furthermore, in a case where the key cannot be updated by the update deadline, communication of image data may be continued using a spare key, which is a backup key, set in advance with emphasis on usability. In a case where the update deadline has expired, security processing is performed by both the image sensor 1 and the host processor 2 using spare keys.

In a case where the key cannot be updated by the update deadline, the security processing may be continued by returning the counter value and the IV value to initial values.

### Image Output IF

Here, SLVS-EC, which is one of the image output IFs, will be described.

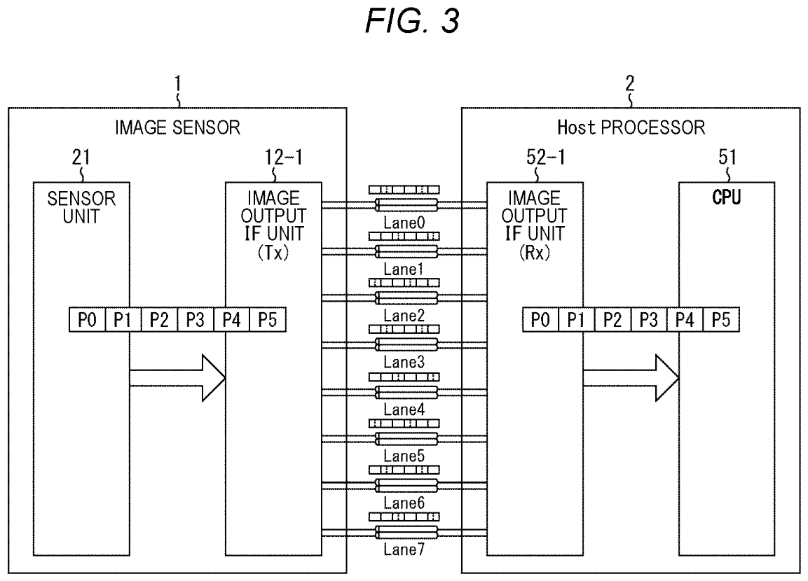

FIG. 3 is a diagram illustrating an example of data transmission through SLVS-EC.

As illustrated in FIG. 3, the image sensor 1 is provided with a sensor unit 21 and an image output IF unit 12-1, and the host processor 2 is provided with an image output IF unit 52-1 and the CPU 51.

The image output IF unit 12-1 of the image sensor 1 and the image output IF unit 52-1 of the host processor 2 are communication units compatible with SLVS-EC. The image output IF unit 12-1 serves as a communication unit on a transmission side, and the image output IF unit 52-1 serves as a communication unit on a reception side. Note that FIG. 3 illustrates only a configuration related to data transmission using the image output IF.

The sensor unit 21 of the image sensor 1 performs photoelectric conversion of light received via a lens. The sensor unit 21 performs A/D conversion and the like on a signal obtained as a result of the photoelectric conversion, and sequentially outputs pixel data constituting an image of one frame to the image output IF unit 12-1, for example, data of one pixel at a time. Security processing by the upper layer data processing unit 11 (FIG. 1) is appropriately performed on the data output from the sensor unit 21, and the data after the security processing is output to the image output IF unit 12-1.

The image output IF unit 12-1 allocates the data of each pixel output from the sensor unit 21 to a plurality of transmission paths and transmits the data to the host processor 2 in parallel via the plurality of transmission paths. In the example of FIG. 3, pixel data is transmitted using eight transmission paths. The transmission paths between the image sensor 1 and the host processor 2 may be wired transmission paths or wireless transmission paths. The transmission paths between the image sensor 1 and the host processor 2 will be referred to as lanes as appropriate.

The image output IF unit 52-1 of the host processor 2 receives the pixel data transmitted from the image output IF unit 12-1 via the eight lanes, and sequentially outputs the data of each pixel to the CPU 51. Data is thus communicated using a plurality of lanes between the image output IF unit 12-1 and the image output IF unit 52-1.

The CPU 51 obtains image data of one frame on the basis of the pixel data supplied from the image output IF unit 52-1, and performs various types of image processing on the obtained image data. In the CPU 51, various types of processing such as compression of the image data and storing of the image data in a storage medium is performed as well as security processing such as decryption of the encrypted image data and tamper detection using a MAC value.

In SLVS-EC, an application layer (Application layer), a link layer (LINK Layer), and a physical layer (PHY Layer) are defined in accordance with content of signal processing. The image output IF unit 12-1 and the image output IF unit 52-1 perform processing in the link layer and the physical layer.

As the processing in the link layer, for example, processing for achieving the following functions is performed.
1. Pixel data-byte data conversion
2. Error correction of payload data
3. Transmission of packet data and auxiliary data
4. Error correction of payload data using packet footer
5. Lane management
6. Protocol management for packet generation

Meanwhile, as the processing in the physical layer, for example, processing for achieving the following functions is performed.
1. Generation and extraction of control code
2. Bandwidth control
3. Control of skew between lanes
4. Arrangement of symbols
5. Symbol coding for bit synchronization
6. SERDES (SERializer/DESerializer)
7. Generation and reproduction of clock
8. Transmission of scalable low voltage signaling (SLVS) signal

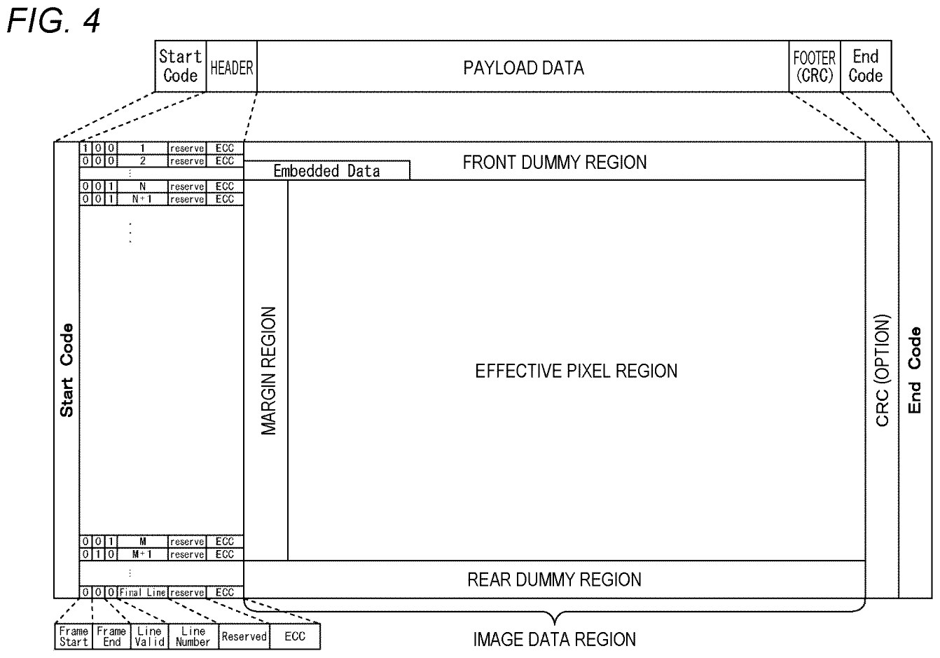

FIG. 4 is a diagram illustrating an example of a format used for data transmission of SLVS-EC.

An effective pixel region is a region of effective pixels of an image of one frame captured by the sensor unit 21. A margin region is arranged on the left side of the effective pixel region.

A front dummy region is arranged on an upper side of the effective pixel region. In the example of FIG. 4, Embedded Data is provided in the front dummy region. Embedded Data includes, for example, information regarding setting values relating to imaging by the sensor unit 21, such as a shutter speed, an aperture value, and a gain. In addition to the information regarding the setting values related to imaging, various types of additional information such as Contents, format, and data size are appropriately provided as Embedded Data. Embedded Data is additional information added to the image data of each frame.

A rear dummy region is arranged on the lower side of the effective pixel region. Embedded Data may be provided in the rear dummy region, instead.

The effective pixel region, the margin region, the front dummy region, and the rear dummy region constitute an image data region.

A header is added before each of lines constituting the image data region, and Start Code is added before the header. Furthermore, a footer is optionally added after each line constituting the image data region, and a control code such as End Code is added after the footer. In a case where no footer is added, a control code such as End Code is added after each line constituting the image data region.

Data transmission is performed using frame data in the format illustrated in FIG. 4 for each image of one frame captured by the sensor unit 21.

An upper band in FIG. 4 illustrates a structure of a packet used to transmit the frame data illustrated below. Assuming that arrangement of data in a horizontal direction is a line, data constituting one line of the image data region is stored in a payload of the packet. The entire frame data of one frame is transmitted using a number of packets larger than or equal to the number of pixels in a vertical direction of the image data region. Furthermore, the entire frame data of one frame is transmitted, for example, by transmitting a packet storing data in units of lines in order from data arranged in an upper line.

One packet is configured by adding a header and a footer to a payload storing data for one line. At least Start Code and End Code, which are control codes, are added to each packet.

As illustrated in a lower left part of FIG. 4, the header includes additional information regarding data stored in the payload, such as Frame Start, Frame End, Line Valid, and Line Number.

Frame Start is 1-bit information indicating a beginning of a frame. A value of 1 is set to Frame Start of a header of a packet used for transmission of data of the first line of frame data, and a value of 0 is set to Frame Start of a header of a packet used for transmission of data of another line.

Frame End is 1-bit information indicating an end of a frame. A value of 1 is set to Frame End of a header of a packet including data of an end line of frame data, and a value of 0 is set to Frame End of a header of a packet used for transmission of data of another line.

Line Valid is 1-bit information indicating whether or not a line of data stored in the packet is a line of effective pixels. A value of 1 is set to Line Valid of a header of a packet used for transmission of pixel data of a line in the effective pixel region, and a value of 0 is set to Line Valid of a header of a packet used for transmission of data of another line.

Line Number is 13-bit information indicating a line number of a line in which data stored in a packet is arranged.

Even in a case where the image output IF unit 12-1 of the image sensor 1 and the image output IF unit 52-1 of the host processor 2 are IFs compatible with a standard different from SLVS-EC, image data of each frame is transmitted using frame data having a similar format.

### Configuration of Image Sensor 1 and Host Processor 2

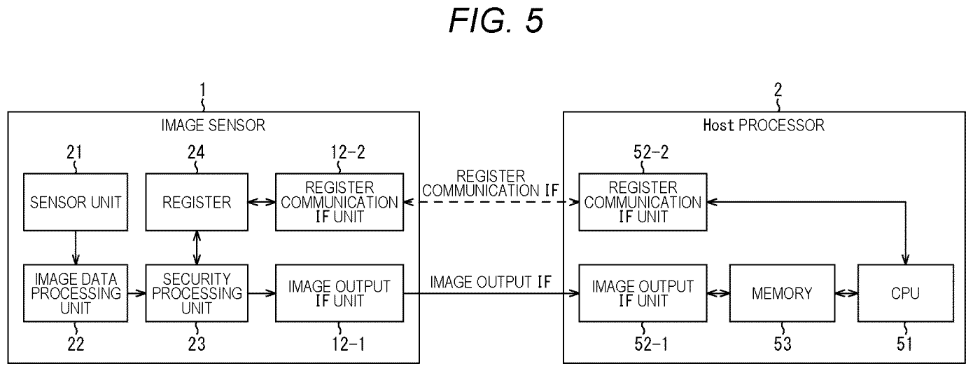

FIG. 5 is a block diagram illustrating a configuration example of the image sensor 1 and the host processor 2. Among components illustrated in FIG. 5, the same components as those described above are given the same reference numerals. Redundant description is omitted as appropriate.

### Configuration of Image Sensor 1

The image sensor 1 is provided with an image data processing unit 22, a security processing unit 23, a register 24, and a register communication IF unit 12-2 in addition to the sensor unit 21 and the image output IF unit 12-1.

The image data processing unit 22 and the security processing unit 23 correspond to the upper layer data processing unit 11 in FIG. 1. Furthermore, the image output IF unit 12-1 and register communication IF unit 12-2 correspond to the communication unit 12 in FIG. 1.

The image data processing unit 22 obtains pixel data output from the sensor unit 21 and performs processing in an application layer (upper layer) on image data of each frame. Frame data having a predetermined format is generated as a result of the processing in the application layer. The image data processing unit 22 outputs data constituting the frame data to the security processing unit 23.

The security processing unit 23 performs security processing according to the security mode on the basis of image data of each frame.

For example, in a case where a security mode for encrypting image data is set, the security processing unit 23 encrypts image data supplied from the image data processing unit 22 using a key. For the encryption of the image data, a counter value, an IV value, and the like managed by the security processing unit 23 are appropriately used.

Furthermore, in a case where a security mode for performing tamper detection is set, the security processing unit 23 performs MAC operation using a key on image data to calculate a MAC value. The security processing unit 23 outputs image data subjected to the security processing and frame data in which a MAC value, an IV value, and the like are arranged in corresponding regions to image output IF unit 12-1.

The security processing unit 23 sets a key used for the security processing on the basis of information transmitted from the host processor 2 using the register communication IF. The security processing unit 23 appropriately updates the key in accordance with settings made by the host processor 2.

Furthermore, the security processing unit 23 manages the key update timing. In a case where the key update timing has come, the security processing unit 23 transmits a key update warning to the host processor 2. A predetermined timing before a key update deadline is set as the key update timing.

In a case where the key update warning is transmitted using the image output IF, the security processing unit 23 arranges the key update warning in a predetermined region of frame data, and outputs the frame data in which the key update warning is arranged to the image output IF unit 12-1.

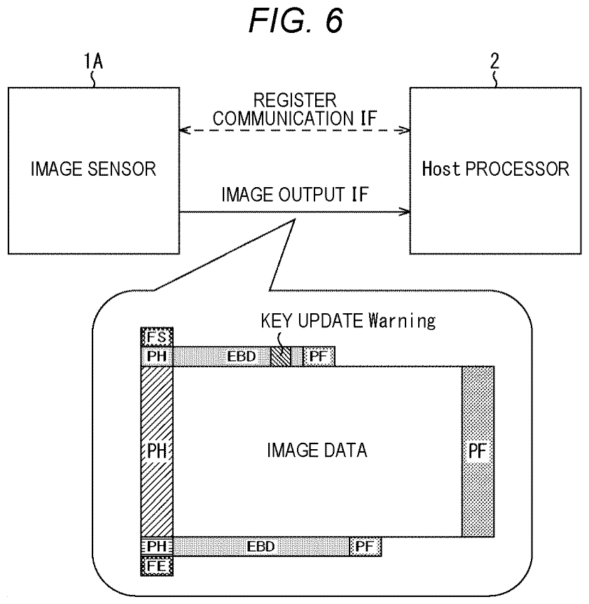

FIG. 6 is a diagram illustrating an arrangement example of the key update warning.

The key update warning, which is information used for notification of a key update timing, is included in, for example, Embedded Data (EBD) of frame data and transmitted to the host processor 2 as indicated by hatching in FIG. 6. In addition to the key update warning, information indicating a period until a key update deadline may be included in EBD.

The frame format illustrated in FIG. 6 is configured by arranging EBD in a line before image data for one frame (image data subjected to security processing). Image data for one frame, which is data of a plurality of lines, is arranged after the line in which EBD is arranged.

A Frame Start (FS) line and a Frame End (FE) line are arranged at a head and an end of the frame format, respectively. The Frame Start line is a line of data in which a value of 1 is set to Frame Start of the packet header. Furthermore, the Frame End line is a line of data in which a value of 1 is set to Frame End of the packet header. In FIG. 6, the packet header is indicated as “PH” and the packet footer is indicated as “PF”.

Returning to the description of FIG. 5, in a case where the key update warning is transmitted using the register communication IF, the security processing unit 23 sets a value indicating the key update warning in the register 24 and transmits the value to the host processor 2. A region used to transmit the key update warning is secured in the register 24.

As described above, the security processing unit 23 functions as a control unit that controls security processing such as encryption and MAC calculation on the image data of each frame output from the sensor unit 21 and transmission of the key update warning to the host processor 2 that is a transmission destination of the image data.

The image output IF unit 12-1 performs signal processing in the link layer on the data supplied from security processing unit 23. As the signal processing in the link layer, generation of a packet storing frame data, processing for distributing packet data to a plurality of lanes, and the like are performed in addition to the above-described processing.

Furthermore, the image output IF unit 12-1 performs signal processing in the physical layer on the data of each packet. As the signal processing in the physical layer, processing including processing for inserting a control code into a packet distributed to each lane is performed in parallel for the lane. A data stream of each lane is transmitted from the image output IF unit 12-1 to the image output IF unit 52-1. The image output IF unit 12-1 functions as a first communication unit that transmits frame data including the image data subjected to the security processing to the host processor 2 using the image output IF.

The register 24 stores various types of data on the basis of control by the security processing unit 23 or on the basis of a command transmitted from the host processor 2 and received by the register communication IF unit 12-2. The data stored in the register 24 is read by the security processing unit 23 as appropriate, and is transmitted to the host processor 2 in response to reception of a read command by the register communication IF unit 12-2.

The register communication IF unit 12-2 performs register communication with the register communication IF unit 52-2 of the host processor 2 to communicate various types of data. For example, the register communication IF unit 12-2 transmits a key update warning to the register communication IF unit 52-2. The register communication IF unit 12-2 functions as a second communication unit that performs register communication using the register 24 with the host processor 2.

### Configuration of Host Processor 2

The host processor 2 is provided with a register communication IF unit 52-2 and a memory 53 in addition to the image output IF unit 52-1 and the CPU 51.

The CPU 51 and the memory 53 correspond to the upper layer data processing unit 51 in FIG. 1. Furthermore, the image output IF unit 52-1 and the register communication IF unit 52-2 correspond to the communication unit 52 in FIG. 1.

The image output IF unit 52-1 receives a data stream transmitted from the image output IF unit 12-1, and performs signal processing in the physical layer on the received data stream. As the signal processing in the physical layer, processing including symbol synchronization processing and control code removal is performed in parallel for each lane in addition to the above-described processing. By performing the signal processing in the physical layer, a data stream including a packet storing data constituting frame data is generated.

Furthermore, the image output IF unit 52-1 performs signal processing in the link layer on data obtained as a result of the signal processing in the physical layer. As the processing in the link layer, for example, processing for integrating data streams of a plurality of lanes into single-sequence data and processing for obtaining packets constituting the data streams are performed.

The image output IF unit 52-1 stores, in the memory 53, the data extracted from the packets obtained by performing the processing in the link layer. The memory 53 stores frame data transmitted from the image sensor 1 using the image output IF. The image output IF unit 52-1 thus functions as a first communication unit that receives frame data transmitted from the image sensor 1 using the image output IF.

The CPU 51 performs processing in the application layer on the frame data stored in the memory 53. The CPU 51 performs security processing according to the security mode on the basis of the image data of each frame as the processing in the application layer.

In a case where a security mode for encrypting image data is set, for example, the CPU 51 decrypts encrypted image data using the key. For the decryption of the image data, a counter value, an IV value, or the like is appropriately used.

Furthermore, in a case where a security mode for performing tamper detection is set, the CPU 51 performs MAC operation using a key on image data to calculate a MAC value. The CPU 51 performs the tamper detection on the image data by comparing the calculated MAC value with a MAC value arranged in a certain region of frame data.

The CPU51 controls the register communication IF unit 52-2 to perform register communication with the image sensor 1. For example, the CPU 51 updates the key by performing the register communication with the image sensor 1 in response to transmission of a key update warning. The CPU 51 functions as a control unit that control key update in response to the transmission of the key update warning from the image sensor 1.

The register communication IF unit 52-2 transmits a write command or a read command to the image sensor 1 under the control of the CPU 51 to perform register communication with the image sensor 1. The register communication IF unit 52-2 functions as a second communication unit that performs the register communication with the image sensor 1. The data received by the register communication IF unit 52-2 is supplied to the CPU 51.

### Operation Example Related to Key Update

A series of operations performed by the image sensor 1 and the host processor 2 configured as above will be described.

Here, it is assumed that a key update warning is transmitted using the image output IF.

### Operation in a Case Where Key Update is Performed

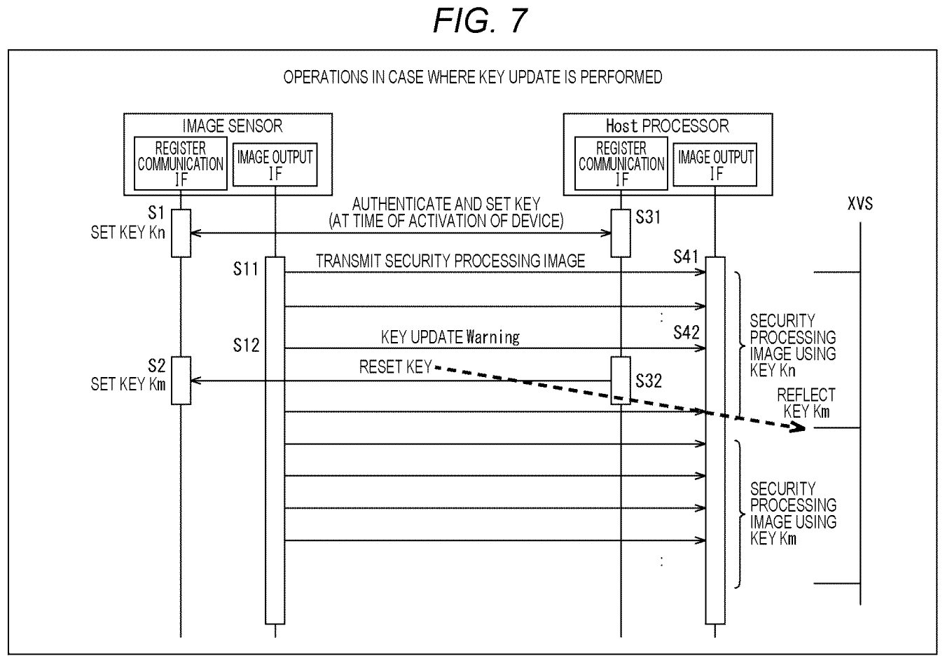

Operations in a case where key update is performed before an update deadline expires will be described with reference to a sequence of FIG. 7.

After the image sensor 1 and the host processor 2 are activated, the CPU 51 of the host processor 2 performs, in step S31, register communication with the image sensor 1 and authenticates the device. If the authentication is successful, the CPU 51 sets a key.

In step S1, on the other hand, the security processing unit 23 of the image sensor 1 performs register communication with the host processor 2 to authenticate the device authentication and set a key. For example, the host processor 2 transmits information indicating which key is to be used to the image sensor 1, and the key is set. In the example in FIG. 7, a key Kn, which is a common key, is set.

In step S11, transmission of image data using the image output IF is started. The data transmitted using the image output IF is data subjected to security processing using the key Kn.

That is, the security processing unit 23 of the image sensor 1 performs the security processing using the key Kn on the image data, and generates frame data in which the image data subjected to the security processing is arranged. The image output IF unit 12-1 transmits the frame data generated by the security processing unit 23 to the host processor 2.

In step S41, reception of the image data transmitted using the image output IF is started. The image output IF unit 52-1 of the host processor 2 receives frame data transmitted from the image sensor 1. The CPU 51 performs security processing (decryption or a MAC check) on the image data included in the frame data using the key Kn.

The above-described communication of image data is repeated between the image sensor 1 and the host processor 2 using the key Kn.

In a case where a key update timing has come, the security processing unit 23 of the image sensor 1 generates, in step S12, frame data in which a key update warning is arranged in EBD. The image output IF unit 12-1 transmits the frame data generated by the security processing unit 23 to the host processor 2.

In step S42, the image output IF unit 52-1 of the host processor 2 receives the frame data transmitted from the image sensor 1. The CPU 51 recognizes that the key update timing has come by performing security processing on the image data and obtaining the key update warning from EBD.

In step S32, the CPU 51 resets the key using the register communication IF. For example, information indicating which key is to be used is transmitted to the image sensor 1.

In step S2, the security processing unit 23 of the image sensor 1 receives the information transmitted using the register communication IF and updates the key. In the example in FIG. 7, a key Km is set instead of the key Kn.

As illustrated on a right side of FIG. 7, the setting of the key Km is reflected at a predetermined timing such as a timing of a vertical synchronization signal. After the setting of the key Km is reflected, communication of image data using the key Km is started between the image sensor 1 and the host processor 2.

As described above, by including a key update warning in EBD and transmitting the key update warning together with image data using the image output IF, the image sensor 1 can spontaneously notify of an update timing of a key.

If the key update warning is transmitted using the register communication IF, it is necessary to repeatedly transmit a read command for reading an update timing managed by each image sensor 1 from the host processor 2 to each image sensor 1, but such processing becomes unnecessary.

### Operations 1 in Case Where Key Update is Not Performed

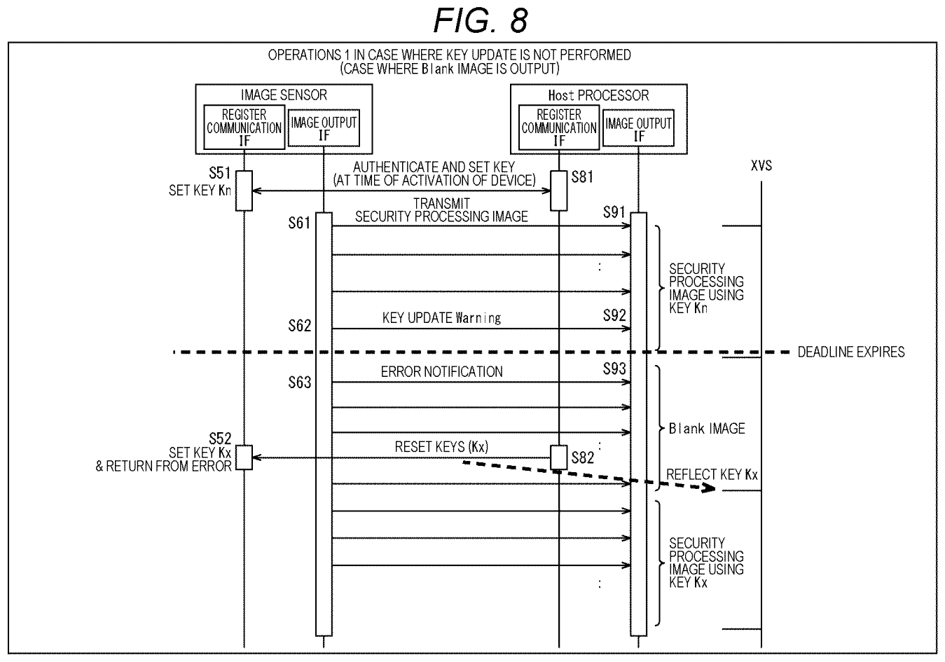

Next, operations in a case where the key update is not performed will be described with reference to a sequence of FIG. 8.

In the example in FIG. 8, in a case where a key update deadline has expired without performing the key update, transmission of blank image data is started. Description overlapping the description of FIG. 7 is omitted as appropriate.

After the image sensor 1 and the host processor 2 are activated, authentication of a device and setting of a key are performed, in steps S51 and S81, between the image sensor 1 and the host processor 2. After the key Kn is set, communication of image data is started in steps S61 and S91. Communication of image data using the key Kn is repeated.

At a key update timing, the image sensor 1 transmits, in step S62, frame data in which a key update warning is arranged in EBD, and the host processor 2 receives the frame data in step S92.

In a case where the update deadline has expired as indicated by a broken line in FIG. 8, the security processing unit 23 of the image sensor 1 generates, in step S63, frame data in which an error notification is arranged in EBD. Blank image data is used as image data constituting the frame data. The image output IF unit 12-1 transmits the frame data generated by the security processing unit 23 to the host processor 2. In this example, the image output IF is used to notify that the image data is in an error state.

In step S93, the image output IF unit 52-1 of the host processor 2 receives the frame data transmitted from the image sensor 1. The CPU 51 recognizes that the key update deadline has expired on the basis of the error notification, and discards the blank image data (does not perform processing).

The above-described communication of blank image data is repeated between the image sensor 1 and the host processor 2.

In a case where the key can be reset, the CPU51 resets the key using the register communication IF in step S82. In the example in FIG. 8, a key Kx is set instead of the key Kn.

In step S52, the security processing unit 23 of the image sensor 1 receives the information transmitted using the register communication IF and updates the key. Furthermore, the security processing unit 23 returns the state of the image data from the error state in response to the key being updated to the key Kx. Transmission of normal image data, not the blank image data, is started.

In a case where the key is updated, the setting of the key Kx is reflected as illustrated on a right side of FIG. 8, and communication of image data using the key Kx is started between the image sensor 1 and the host processor 2.

As described above, in a case where the update deadline has expired, the image sensor 1 can notify the host processor 2 that the state of the image data is an error state by adding an error notification to each piece of blank image data.

Furthermore, the host processor 2 can easily recognize that the blank image data is unreliable data on the basis of the error notification transmitted together with the blank image data.

If it is assumed that the error notification is transmitted using the register communication IF, the host processor 2 that has received the notification needs to identify which image data transmitted using the image output IF is the image data for which the error notification has been issued, but such processing becomes unnecessary.

### Operations 2 in Case Where Key Update is Not Performed

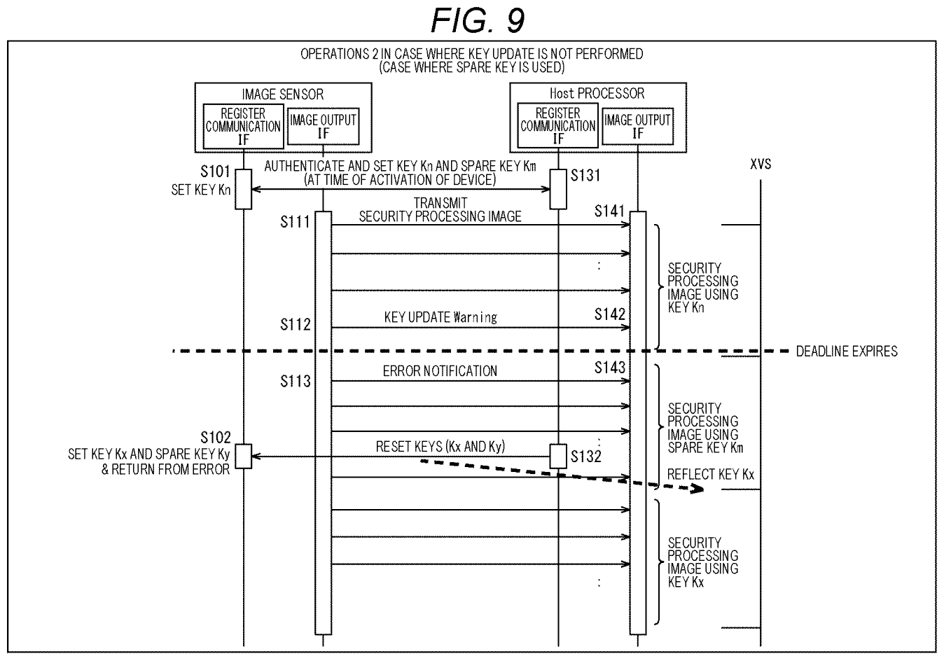

Next, other operations in a case where the key update is not performed will be described with reference to a sequence of FIG. 9.

In an example in FIG. 9, in a case where the key update deadline has expired without performing the key update, the communication of image data is continued using a spare key. Description overlapping the description of FIGS. 7 and 8 is omitted as appropriate.

After the image sensor 1 and the host processor 2 are activated, authentication of a device is performed, in steps S101 and S131, between the image sensor 1 and the host processor 2. Furthermore, if the authentication is successful, a key and a spare key are set.

In the example in FIG. 9, the key Kn and the spare key Km are set. After the key Kn and the spare key Km are set, communication of image data is started in steps S111 and S141. Communication of image data using the key Kn is repeated.

At a key update timing, the image sensor 1 transmits, in step S112, frame data in which a key update warning is arranged in EBD, and the host processor 2 receives the frame data in step S142.

In a case where the update deadline has expired as indicated by a broken straight line in FIG. 9, the security processing unit 23 of the image sensor 1 performs security processing on the image data using the spare key Km in step S113. In response to the expiration of the update deadline, the key used for the security processing is switched from the key Kn to the spare key Km.

Furthermore, the security processing unit 23 generates frame data in which an error notification is arranged in EBD. The image data subjected to the security processing using the spare key Km is used as the image data constituting the frame data. The image output IF unit 12-1 transmits the frame data generated by the security processing unit 23 to the host processor 2.

In step S143, the image output IF unit 52-1 of the host processor 2 receives the frame data transmitted from the image sensor 1. The CPU 51 recognizes that the key update deadline has expired on the basis of the error notification, and switches the key used for the security processing from the key Kn to the spare key Km. The CPU 51 performs the security processing on the image data constituting the frame data using the spare key Km.

The above-described communication of image data is repeated between the image sensor 1 and the host processor 2 using the key Km.

In a case where the key can be reset, the CPU51 resets the key using the register communication IF in step S132. In the example in FIG. 9, the key Kx is set instead of the spare key Km. Furthermore, a spare key Ky is set as a spare key of the key Kx.

In step S102, the security processing unit 23 of the image sensor 1 receives the information transmitted using the register communication IF and updates the key and the spare key. Furthermore, the security processing unit 23 returns the state of the image data from the error state in response to the key being updated to the key Kx.

In a case where the key and the spare key are updated, the setting of the key Kx is reflected as illustrated on a right side of FIG. 9, and communication of image data using the key Kx is started between the image sensor 1 and the host processor 2.

As described above, in a case where the update deadline has expired, both the image sensor 1 and the host processor 2 switch to the spare key, so that the communication of image data can be continued while ensuring security.

### Key Update Timing

The IV value used for encryption of image data is updated every time one unit of data is processed. In a case where the IV value is updated through incrementing, for example, the key is updated before the IV value exceeds a maximum value.

The security processing unit 23 of the image sensor 1 determines, on the basis of the maximum value of the IV value, how many more units of image data are to be processed before updating the key, and manages the timing of the key update warning. For example, the key update warning is transmitted at a timing after processing of image data a predetermined number of units before image data with which the IV value becomes the maximum value.

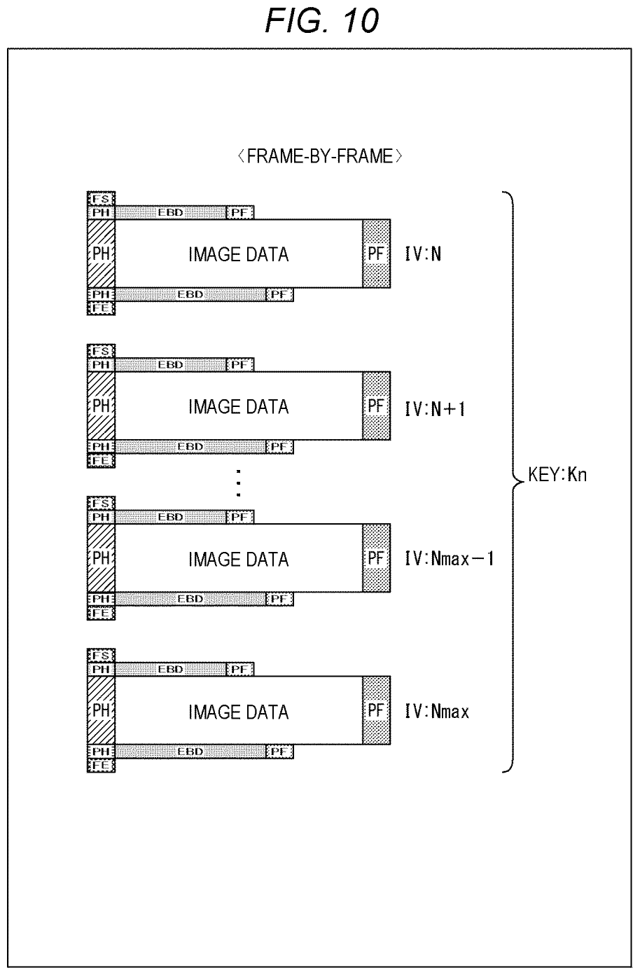

FIG. 10 is a diagram illustrating an example of a case where the IV value is updated every time image data of one frame is processed.

In the example of FIG. 10, a value N is used as an IV value for security processing of image data of a first frame, and a value N+1 is used as an IV value for security processing of image data of a second frame that is image data of a next one unit.

Similarly, the IV value is incremented every time image data of one frame is processed, and the key Kn is updated after a value Nmax is used as the IV value.

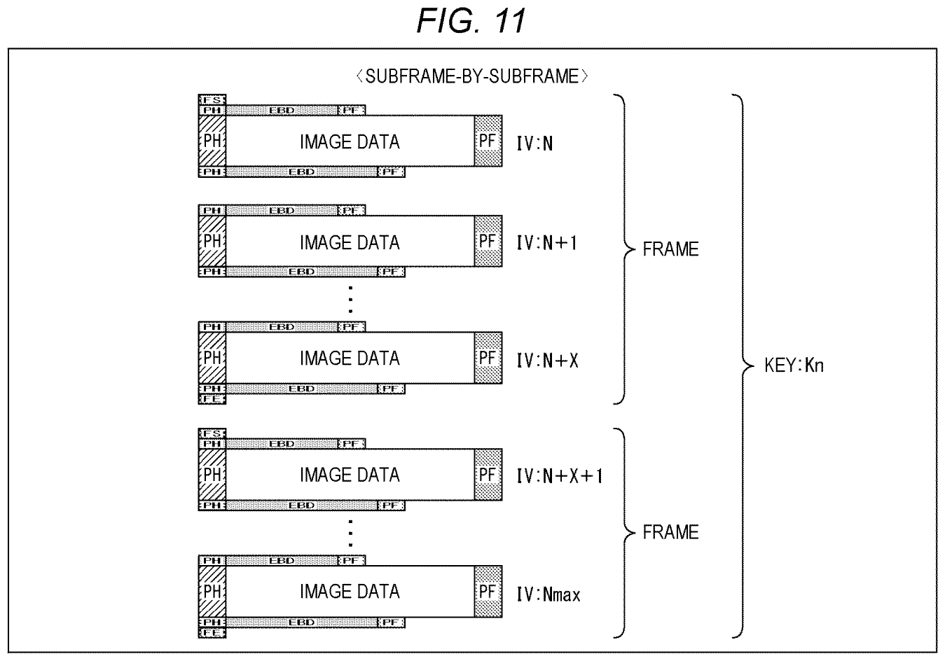

FIG. 11 is a diagram illustrating an example of a case where the IV value is updated every time image data of one subframe is processed. Image data of one frame includes image data of a plurality of subframes. One subframe includes a plurality of lines.

In the example in FIG. 11, a value N is used as an IV value for security processing of image data of a first subframe included in image data of a first frame, and a value N+1 is used as an IV value for security processing of image data of a second subframe that is image data of a next one unit. Values N+2 and more are used as IV values for security processing of image data of third and subsequent subframes, and a value N+X is used as an IV value for security processing of image data of a last subframe included in the image data of the first frame.

Similarly, the IV value is incremented every time image data of one subframe is processed, and the key Kn is updated after a value Nmax is used as the IV value.

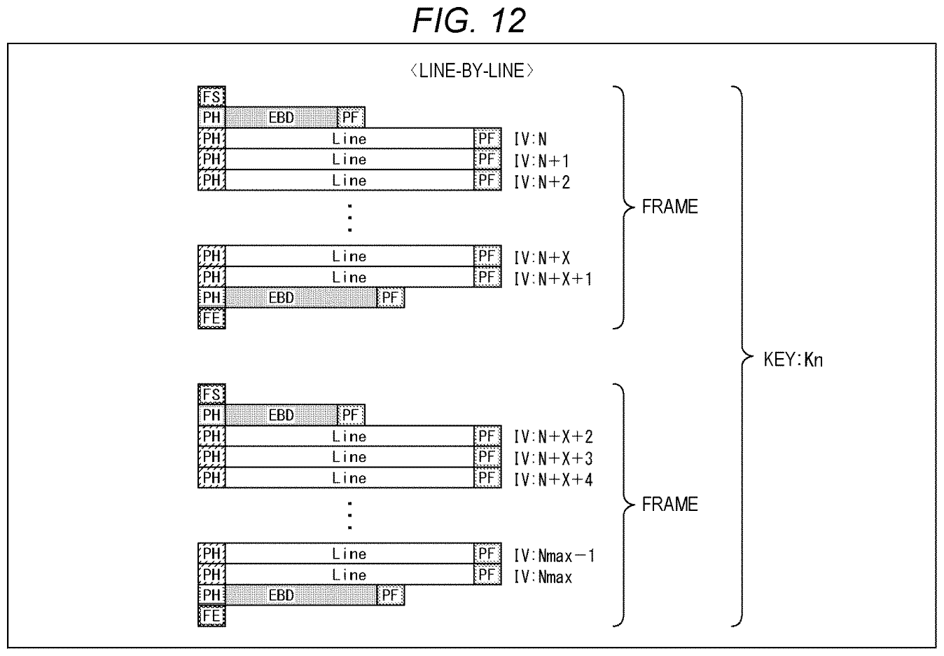

FIG. 12 is a diagram illustrating an example of a case where the IV value is updated every time image data of one line is processed.

In the example in FIG. 12, a value N is used as an IV value for security processing of image data of a first line included in image data of a first frame, and a value N+1 is used as an IV value for security processing of image data of a second line that is image data of a next one unit. Values N+2 and more are used as IV values for security processing of image data of third and subsequent lines, and a value N+X+1 is used as an IV value for security processing of image data of a last line included in the image data of the first frame.

Similarly, the IV value is incremented every time image data of one line is processed, and the key Kn is updated after a value Nmax is used as the IV value.

As described above, as a timing for updating the IV value, a timing after processing of image data of one of various units including a frame, a subframe, and a line can be employed, for example.

It is particularly difficult for the host processor 2 to manage the key update timing together with the update of the IV value in a case where the update of the IV value is performed in units of subframes or lines. If image sensors 1 update IV values and manage key update timings, the host processor 2 can easily update the keys even in a case where the number of image sensors 1 connected thereto is large.

The timing of a key update warning may be changed on the basis of the following factors.
Time required for the host processor 2 to generate a key after recognizing a key update warning
Time required for the image sensor 1 to set a key after receiving the key

The timing of a key update warning and a method of changing the timing may be determined by the host processor 2 and set for the image sensor 1 through register communication.

### MODIFICATIONS

### Example of Transmission of Key Update Warning and Error Notification

The key update warning and the error notification are transmitted using the image output IF, but may be transmitted using the register communication IF. Furthermore, a portion for the key update warning and a port for the error notification may be provided in each of the image sensor 1 and the host processor 2.

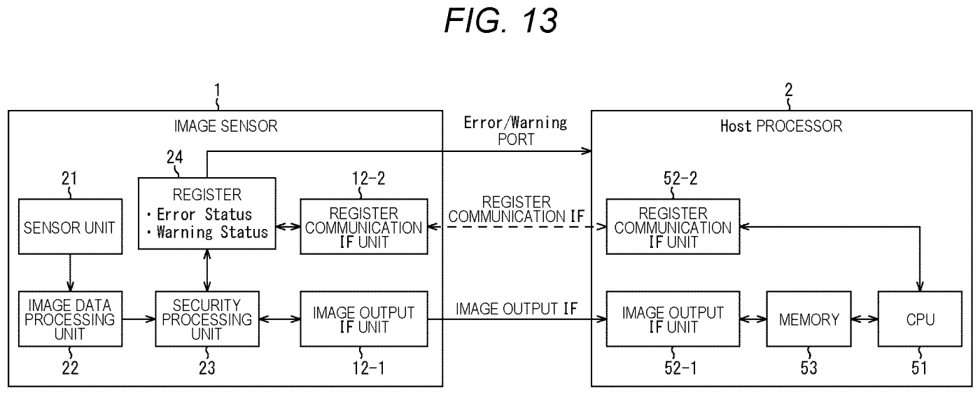

FIG. 13 is a diagram illustrating another configuration example of the communication system. Among components illustrated in FIG. 13, the same components as those illustrated in FIG. 5 are given the same reference numerals. Redundant description is omitted as appropriate.

In a case where the key update warning and the error notification are transmitted using the register communication IF or a dedicated port, Warning Status, which is a region for the key update warning, and Error Status, which is a region for the error notification, are secured in the register 24 as illustrated in FIG. 13.

In a case where the key update timing has come, the security processing unit 23 sets a value indicating that the key update timing has come to Warning Status of the register 24, thereby transmitting a key update warning to the host processor 2 using the register communication IF or a dedicated port.

Furthermore, in a case where the update deadline has expired, the security processing unit 23 sets a value indicating that the state of the image data is an error state to Error Status of the register 24, thereby transmitting an error notification to the host processor 2 using the register communication IF or a dedicated port.

As a result, the image sensor 1 can also notify the host processor 2 of the key update timing and that the state of the image data is an error state.

### Others

Although a key update warning is transmitted only once in a case where a key update timing has come, a key update warning may be repeatedly transmitted until an update deadline expires. In this case, frame data in which a key update warning is arranged in EBD is repeatedly transmitted.

Although frame data is generated using image data of each frame captured by the sensor unit 21 as output data and transmitted to the host processor 2, other types of data in units of frames may be used as the output data, instead. For example, a distance image in which a distance to each position of a subject is a pixel value of each pixel can be used as the output data.

The series of processing steps described above can be executed by hardware and also can be executed by software. In a case where the series of processes is executed by software, a program included in the software is installed from a program recording medium to a computer incorporated in dedicated hardware, a general-purpose personal computer, or the like.

The program to be installed is provided by being recorded in the removable medium including an optical disk (Compact Disc-Read Only Memory (CD-ROM), Digital Versatile Disc (DVD), and the like), a semiconductor memory, or the like. Furthermore, the program may be provided via a wired or wireless transmission medium such as a local area network, the Internet, or digital broadcasting. Furthermore, the program can be installed in a ROM or a storage unit in advance.

Note that the program executed by the computer may be a program whose processing is performed chronologically in the order described herein or may be the program whose processing is performed in parallel or at required timing such as when a call is issued.

In the present description, a system means a set of a plurality of components (devices, modules (parts), and the like), and it does not matter whether or not all the components are in the same housing. Therefore, a plurality of devices housed in separate housings and connected to each other via a network and one device in which a plurality of modules is housed in one housing are both systems.

The effects described in the specification are merely examples and are not limited, and other effects may be provided.

An embodiment of the present technology is not limited to the embodiment described above, and various modifications can be made without departing from the scope of the present technology.

Furthermore, each step described in the above flowcharts can be performed by one device, or can be performed in a shared manner by a plurality of devices.

Moreover, in a case where a plurality of processing steps is included in one step, the plurality of processing steps included in the one step can be performed by one device or can be performed in a shared manner by a plurality of devices.

### Exemplary Configuration Combinations

The present technology may also have the following configurations.
(1)

A transmission device including:
a control unit that controls security processing performed on output data of each of frames output by a sensor and transmission of information indicating an update timing of a key used for the security processing to a reception device that is a transmission destination of the output data; and
a first communication unit that transmits, using a first communication IF, frame data in a predetermined format used for transmission of the output data subjected to the security processing.
(2)

The transmission device according to (1), in which
in a case where an update deadline of the key has expired, the control unit transmits, to the reception device, information indicating that a state of the output data is an error state.
(3)

The transmission device according to (1) or (2), in which
the control unit transmits information indicating a period until the update deadline.
(4)

The transmission device according to (2) or (3), in which
the control unit transmits the information indicating the update timing by including the information indicating the update timing in additional information arranged in a predetermined line of the frame data.
(5)

The transmission device according to (4), in which
the control unit transmits the information indicating the error state by including the information indicating the error state in the additional information.
(6)

The transmission device according to (2), further including:
a second communication unit that performs communication with the reception device via a second communication IF using a register, in which
the control unit updates the key in accordance with a setting made by the reception device using the second communication IF.
(7)

The transmission device according to (6), in which
the control unit transmits the information indicating the update timing using the second communication IF.
(8)

The transmission device according to (6) or (7), in which
the control unit transmits the information indicating the error state using the second communication IF.
(9)

The transmission device according to (2), in which
the control unit transmits the information indicating the update timing using a dedicated port.
(10)

The transmission device according to (9), in which
the control unit transmits the information indicating the error state using the dedicated port.
(11)

An information processing method performed by a transmission device, the information processing method including
controlling security processing performed on output data of each of frames output by a sensor and transmission of information indicating an update timing of a key used for the security processing to a reception device that is a transmission destination of the output data; and
transmitting frame data in a predetermined format used for transmission of the output data subjected to the security processing.
(12)

A program causing a computer to perform a process including:
controlling security processing performed on output data of each of frames output by a sensor and transmission of information indicating an update timing of a key used for the security processing to a reception device that is a transmission destination of the output data; and
transmitting frame data in a predetermined format used for transmission of the output data subjected to the security processing.
(13)

A reception device including:
a first communication unit that receives frame data in a predetermined format including output data of each of frames that has been output by a sensor and on which security processing has been performed, the frame data being transmitted, using a first communication IF, from a transmission device that performs the security processing on the output data; and
a control unit that controls update of a key used for the security processing in response to transmission of information indicating an update timing of the key from the transmission device.
(14)

The reception device according to (13), in which
the first communication unit receives the frame data in which additional information including the information indicating the update timing is arranged in a predetermined line.
(15)

The reception device according to (13) or (14), further including:
a second communication unit that communicates with the transmission device via a second communication IF using a register of the transmission device, in which
the control unit controls the update of the key using the communication via the second communication IF.
(16)

The reception device according to (15), in which
the control unit controls the update of the key in response to transmission of the information indicating the update timing using the second communication IF.
(17)

The reception device according to (13), in which
the control unit controls the update of the key in response to transmission of the information indicating the update timing using a dedicated port.
(18)

An information processing method performed by a reception device, the information processing method including:
receiving frame data in a predetermined format including output data of each of frames that has been output by a sensor and on which security processing has been performed, the frame data being transmitted from a transmission device that performs the security processing on the output data; and
controlling update of a key used for the security processing in response to transmission of information indicating an update timing of the key from the transmission device.
(19)

A program causing a computer to perform a process including:
receiving frame data in a predetermined format including output data of each of frames that has been output by a sensor and on which security processing has been performed, the frame data being transmitted from a transmission device that performs the security processing on the output data; and
controlling update of a key used for the security processing in response to transmission of information indicating an update timing of the key from the transmission device.
(20)

A communication system including:
a transmission device including
a control unit that controls security processing performed on output data of each of frames output by a sensor and transmission of information indicating an update timing of a key used for the security processing to a reception device that is a transmission destination of the output data, and
a communication unit that transmits frame data in a predetermined format used for transmission of the output data subjected to the security processing; and
the reception device including
a communication unit that receives the frame data transmitted from the transmission device, and
a control unit that controls update of the key in response to the transmission of the information indicating the update timing from the transmission device.

### REFERENCE SIGNS LIST

1A, 1B Image sensor
2 Host processor
11 Upper layer data processing unit
12 Communication unit
12-1 Image output IF unit
12-2 Register communication IF unit
21 Sensor unit
22 Image data processing unit
23 Security processing unit
24 Register
51 Upper layer data processing unit (CPU)
52 Communication unit
52-1 Image output IF unit
52-2 Register communication IF unit
53 Memory

1. A transmission device comprising:
a control unit that controls security processing performed on output data of each of frames output by a sensor and transmission of information indicating an update timing of a key used for the security processing to a reception device that is a transmission destination of the output data; and
a first communication unit that transmits, using a first communication IF, frame data in a predetermined format used for transmission of the output data subjected to the security processing.

2. The transmission device according to claim 1, wherein
in a case where an update deadline of the key has expired, the control unit transmits, to the reception device, information indicating that a state of the output data is an error state.

3. The transmission device according to claim 1, wherein
the control unit transmits information indicating a period until the update deadline.

4. The transmission device according to claim 2, wherein
the control unit transmits the information indicating the update timing by including the information indicating the update timing in additional information arranged in a predetermined line of the frame data.

5. The transmission device according to claim 4, wherein
the control unit transmits the information indicating the error state by including the information indicating the error state in the additional information.

6. The transmission device according to claim 2, further comprising:
a second communication unit that performs communication with the reception device via a second communication IF using a register, wherein
the control unit updates the key in accordance with a setting made by the reception device using the second communication IF.

7. The transmission device according to claim 6, wherein
the control unit transmits the information indicating the update timing using the second communication IF.

8. The transmission device according to claim 6, wherein
the control unit transmits the information indicating the error state using the second communication IF.

9. The transmission device according to claim 2, wherein
the control unit transmits the information indicating the update timing using a dedicated port.

10. The transmission device according to claim 9, wherein
the control unit transmits the information indicating the error state using the dedicated port.

11. An information processing method performed by a transmission device, the information processing method comprising:
controlling security processing performed on output data of each of frames output by a sensor and transmission of information indicating an update timing of a key used for the security processing to a reception device that is a transmission destination of the output data; and
transmitting frame data in a predetermined format used for transmission of the output data subjected to the security processing.

12. A program causing a computer to perform a process comprising:
controlling security processing performed on output data of each of frames output by a sensor and transmission of information indicating an update timing of a key used for the security processing to a reception device that is a transmission destination of the output data; and
transmitting frame data in a predetermined format used for transmission of the output data subjected to the security processing.

13. A reception device comprising:
a first communication unit that receives frame data in a predetermined format including output data of each of frames that has been output by a sensor and on which security processing has been performed, the frame data being transmitted, using a first communication IF, from a transmission device that performs the security processing on the output data; and
a control unit that controls update of a key used for the security processing in response to transmission of information indicating an update timing of the key from the transmission device.

14. The reception device according to claim 13, wherein
the first communication unit receives the frame data in which additional information including the information indicating the update timing is arranged in a predetermined line.

15. The reception device according to claim 13, further comprising:
a second communication unit that communicates with the transmission device via a second communication IF using a register of the transmission device, wherein
the control unit controls the update of the key using the communication via the second communication IF.

16. The reception device according to claim 15, wherein
the control unit controls the update of the key in response to transmission of the information indicating the update timing using the second communication IF.

17. The reception device according to claim 13, wherein
the control unit controls the update of the key in response to transmission of the information indicating the update timing using a dedicated port.

18. An information processing method performed by a reception device, the information processing method comprising:
receiving frame data in a predetermined format including output data of each of frames that has been output by a sensor and on which security processing has been performed, the frame data being transmitted from a transmission device that performs the security processing on the output data; and
controlling update of a key used for the security processing in response to transmission of information indicating an update timing of the key from the transmission device.

19. A program causing a computer to perform a process comprising:
receiving frame data in a predetermined format including output data of each of frames that has been output by a sensor and on which security processing has been performed, the frame data being transmitted from a transmission device that performs the security processing on the output data; and
controlling update of a key used for the security processing in response to transmission of information indicating an update timing of the key from the transmission device.

20. A communication system comprising:
a transmission device including
a control unit that controls security processing performed on output data of each of frames output by a sensor and transmission of information indicating an update timing of a key used for the security processing to a reception device that is a transmission destination of the output data, and
a communication unit that transmits frame data in a predetermined format used for transmission of the output data subjected to the security processing; and
the reception device including
a communication unit that receives the frame data transmitted from the transmission device, and
a control unit that controls update of the key in response to the transmission of the information indicating the update timing from the transmission device.
